(19) United States
(12) Patent Application Publication
(10) Pub. No.: US 2026/0135460 A1
(43) Pub. Date: May 14, 2026

(54) OPERATION OF A SWITCHING CONVERTER UNDER LIGHT LOAD CONDITIONS

(71) Applicant: Shaoxing Yuanfang Semiconductor Co., Ltd., Shaoxing (CN)

(72) Inventors: Arnold J D'Souza, Bangalore (IN); Shyam Somayajula, Bangalore (IN)

(21) Appl. No.: 19/059,346

(22) Filed: Feb. 21, 2025

(30) Foreign Application Priority Data
Nov. 13, 2024 (IN) 202441087560
Dec. 10, 2024 (IN) 202441097428

(51) Int. Cl. H02M 1/00; H02M 1/08; H02M 3/158

(52) U.S. Cl. CPC H02M 1/0025; H02M 1/0009; H02M 1/08; H02M 3/158

(57) ABSTRACT

A gate driver block of a switching converter drives the high-side switch and the low-side switch such that, in a cycle of a control signal: i. At a first time instance, the low-side switch is turned on with the high-side switch being off; ii. At a second time instance following the first time instance, the low-side switch is turned off with the high-side switch remaining off; and iii. At a third time instance following a delay duration from the second time instance, the high-side switch is turned on with the low-side switch remaining off. By the third time instance, a voltage across an effective parasitic capacitance reaches only a magnitude of a fraction (less than one) of the input voltage, wherein the voltage across the effective parasitic capacitance thereafter rises to the level of the input voltage while the high-side switch continues to be on from the third time instance.

### PRIORITY CLAIM

The instant patent application is related to and claims priority from the co-pending India provisional patent applications: 1) Entitled “SPS (Smart Power Stage) ZVS (Zero Voltage Switching)”, Serial No.: 202441087560, Filed: 13 Nov. 2024, Attorney docket no.: AURA-368-INPR; and 2) Entitled “SPS (Smart Power Stage) ZVS (Zero Voltage Switching)”, Serial No.: 202441097428, Filed: 10 Dec. 2024, Attorney docket no.: AURA-368-INPR2, which are incorporated in their entirety herewith to the extent not inconsistent with the description herein.

### BACKGROUND

### Technical Field

Embodiments of the present disclosure relate generally to switching converters, and more specifically to operation of a switching converter under light load conditions.

### Related Art

Switching converter refers to a component which generates a regulated DC (direct current) voltage from an input supply voltage by employing one or more switches, as is well known in the relevant arts. Switching converters find use as stand-alone power supplies, in voltage regulator modules used in several environments such as laptops, mobile phones, etc.

A switching converter often contains a pair of switches driving an inductor. Each switch is typically implemented as a transistor (e.g., MOSFET) and the switches are connected in series between input supply voltage and a reference terminal (e.g., ground). The switch coupled closer to the input voltage (source of input power to the converter) is termed as the high-side switch, while the other one is termed as a low-side switch. The switches are operated by a control circuit which switches on the transistors in successive non-overlapping time durations to cause the switch that is currently ON to drive the inductor in the corresponding duration.

There are several recognized losses encountered in a switching converter, such as, switching losses, inductor core losses, conduction losses, etc. which reduce the efficiency of the switching converter. As is well known in the relevant arts, efficiency of a switching converter is generally measured as a ratio of output power to the input power.

Switching converters are often operated under light load conditions, i.e., when the load presented at the output is a fraction (e.g., less than 10%) of the maximum rated power. It is generally desirable to operate switching converters with high efficiency even under light load conditions.

Aspects of the present disclosure are directed to operation of a switching converter under light load conditions.

### BRIEF DESCRIPTION OF THE VIEWS OF DRAWINGS

Example embodiments of the present disclosure will be described with reference to the accompanying drawings briefly described below.

FIG. 1 is a block diagram of an example device in which several aspects of the present disclosure can be implemented.

FIG. 2 is a block diagram illustrating the details of a voltage regulator module (VRM) in an embodiment of the present disclosure.

FIG. 3 is a diagram illustrating the implementation details of a power stage in an embodiment of the present disclosure.

FIG. 4A is a timing diagram (not to scale) illustrating the operation of a switching converter under light load conditions, in an embodiment of the present disclosure.

FIG. 4B is a timing diagram (not to scale) illustrating the operation of a switching converter under light load conditions, in an embodiment of the present disclosure.

FIG. 5 is a diagram illustrating the implementation details of a low-side switch in an embodiment of the present disclosure.

FIG. 6 is a diagram illustrating the implementation details of a phase controller in an embodiment of the present disclosure.

FIG. 7 is a diagram illustrating the implementation details of a gate driver block in an embodiment of the present disclosure.

FIG. 8 is a diagram illustrating the implementation details of a negative-threshold voltage detector block in an embodiment of the present disclosure.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

An aspect of the present disclosure is directed to a switching converter containing a high-side switch and a low-side switch coupled in series at a switching node. The switches together provide a regulated supply voltage at an output node based on an input voltage received at an input node. The input voltage is of a first magnitude. The high-side switch and the low-side switch are connected in series between the input node and a ground terminal, and an inductor is coupled between the switching node and the output node, with the high-side switch and the low-side switch respectively driving the inductor based on a control signal. A gate driver block of the switching converter drives each of the high-side switch and the low side switch to be on or off based on a logic level of the control signal. An effective parasitic capacitance is present between the switching node and the ground terminal.

According to an aspect of the present disclosure, the gate driver block drives the high-side switch and the low-side switch such that, in a cycle of the control signal: i. At a first time instance, the low-side switch is turned on with the high-side switch being off; ii. At a second time instance following the first time instance, the low-side switch is turned off with the high-side switch remaining off; and iii. At a third time instance following a delay duration from the second time instance, the high-side switch is turned on with the low-side switch remaining off.

By the third time instance, a voltage across the effective parasitic capacitance reaches only a fraction of the first magnitude, wherein the voltage across the effective parasitic capacitance thereafter rises to the first magnitude while the high-side switch continues to be on from the third time instance, wherein the fraction is less than one.

By charging the capacitor to a level lesser than the first magnitude, an optimum trade-off between the various recognized losses may be achieved, thus improving the efficiency of the switching converter.

According to another aspect of the present disclosure, the cycle of the control signal starts at the first time instance, and the time duration between the first time instance and the second time instance equals a first pre-computed value such that a current through the inductor reaches a pre-determined magnitude by the second time instance, and the delay duration equals a second pre-computed value.

According to one more aspect of the present disclosure, the gate driver block further operates to drive the high-side switch and the low-side switch such that, in the cycle of the control signal: at a fourth time instance following the third time instance, the high-side switch is turned off with the low-side switch remaining off; at a fifth time instance following the fourth time instance, the low-side switch is turned on with the high-side switch remaining off; and at a sixth time instance following the fifth time instance, the low-side switch is turned off with the high-side switch remaining off. By the fifth time instance, a voltage at the SW node reaches a first negative-threshold value, and thereafter rises to zero while the low-side switch is on from the fifth time instance. The current through the inductor reaches zero by the sixth time instance.

Several aspects of the present disclosure are described below with reference to examples for illustration. However, one skilled in the relevant art will recognize that the disclosure can be practiced without one or more of the specific details or with other methods, components, materials and so forth. In other instances, well known structures, materials, or operations are not shown in detail to avoid obscuring the features of the disclosure.

Furthermore, the features/aspects described can be practiced in various combinations, though only some of the combinations are described herein for conciseness.

### 2. Example System

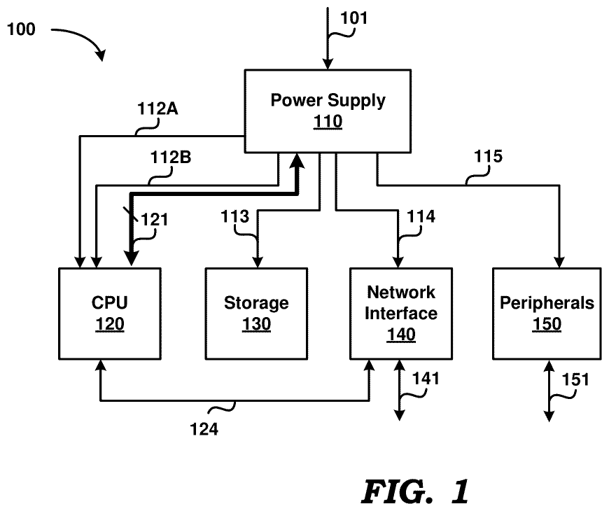

FIG. 1 is a block diagram of an example system in which several aspects of the present disclosure can be implemented. System 100 is shown containing power supply 110, central processing unit (CPU) 120, storage 130, network interface 140 and peripherals 150. In an embodiment, system 100 corresponds to a computer (desktop, laptop, etc.), although system 100 can represent other types of systems in other embodiments. It is understood that system 100 can contain more or fewer blocks than those shown in FIG. 1.

CPU 120, in general, represents a processor or a system-on-chip (SoC), and is shown as receiving a pair of supply voltages (Va and Vb) on respective paths 112A and 112B from power supply 110. As an example, Va may be a lower voltage than Vb, and may be used to power a core portion of CPU which may include arithmetic logic unit (ALU), microprogram sequencer, registers, etc. Vb may be used to power the rest of CPU 120, such as for example, input/output (I/O) units, I/O buffers, on-chip peripherals etc. CPU 120 provides various signals (all deemed to be contained in path 121) specifying, among others, its power supply requirements to power supply 110. Examples of such signals can be those that specify the specific mode of operation (in terms of power consumption) such as PS1, PS2, PS3, etc., which refer to “Power Save States for Improved Efficiency”.

Storage 130 represents a memory that may include both volatile and non-volatile memories. For example, in a personal computer, storage can include magnetic memory (hard disk) as well as solid state memory (RAM, Flash, etc.). Storage 130 is shown receiving a supply voltage on path 113 for powering various circuits and blocks within.

Network interface 140 operates to provide two-way communication between system 100 and a computer network, or in general the Internet. Network interface 140 implements the electronic circuitry required to communicate using a specific physical layer and data link layer standard such as Ethernet or Wi-Fi™. Network interface 140 may also contain a network protocol stack to allow communication with other computers on a same local area network (LAN) and large-scale network communications through routable protocols, such as Internet Protocol (IP). Network interface 140 receives a power supply on path 114 for powering internal circuits and blocks. Network interface 140 receives from/transmits to external systems and CPU 120 respectively on path 141 and path 124.

Peripherals 150 represents one or more peripheral circuits, such as, for example, speakers, microphones, user interface devices, etc. Peripherals 150 receives a power supply on path 115, and communicates with external devices on path 151.

Power supply 110 receives power from one or more sources (e.g., battery) on path 101, and operates to provide the desired power supply voltages on paths 112A, 112B, 113, 114 and 115. In an embodiment, power supply 110 is designed to contain one or more multi-phase DC-DC converters within to generate the power supply voltages. Power supply 110 responds to signals from CPU 120 received on path 121 to control the multi-phase converters to reduce/increase current output based on the specific signal (e.g., PS1, PS2 and PS3).

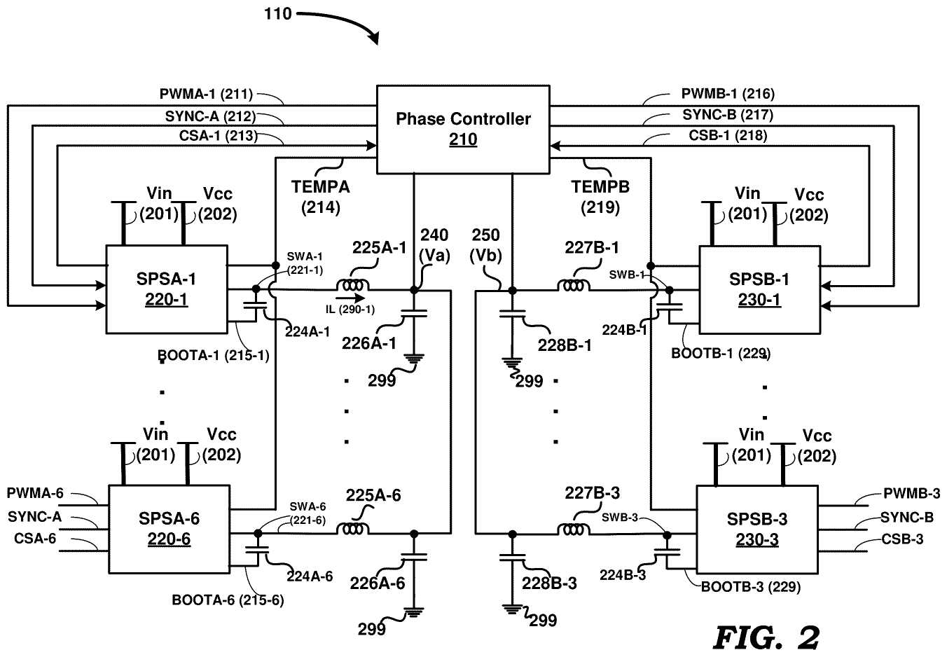

In the embodiment, power supply 110 is a voltage regulator module (VRM), sometimes also called processor power module (PPM), and contains one or more step-down switching (buck) converters to generate several lower voltages from a higher-voltage supply source. In other embodiments however, other types of DC-DC converters such as boost, buck-boost, hysteretic converters etc., can be implemented instead of a buck converter. With a VRM, multiple devices/ICs requiring different supply voltages can be mounted on the same platform, for example, a computer motherboard of a personal computer (PC). Accordingly, the description is continued with respect to a VRM as shown in FIG. 2.

### 3. Voltage Regulator Module (VRM)

FIG. 2 is a block diagram illustrating the details of a VRM in an embodiment of the present disclosure. Power Supply 110 (of FIG. 1) is implemented as a Voltage Regulator Module implemented in the form of a multi-phase switching converter generating two regulated voltages Va (240) and Vb (250).

VRM 110 is shown containing phase controller 210, smart power stages (SPS/power stages) SPSA-1 (220-1) through SPSA-6 (220-6), SPSB-1 (230-1) through SPSB-3 (230-3), inductors 225A-1 through 225A-6 and 227B-1 through 227B-3, output capacitors 226A-1 through 226A-6 and 228B-1 through 228B-3, and bootstrap capacitors 224A-1 through 224A-6, 224B-1 through 224B-3. Each bootstrap capacitor associated with an SPS is shown connected between respective nodes SW and BOOT of the corresponding SPS. Thus, bootstrap capacitor 224A-1 is shown connected between switching node SWA-1 (221-1) and BOOTA-1 (215-1). Although bootstrap capacitor is shown connected external to each SPS, in alternative embodiments, bootstrap capacitor may be internal to the SPS. It is noted here that, in general, the term ‘voltage regulator’ refers to either a stand-alone regulator (such as a stand-alone switching converter) or a portion (such as a smart power stage) of a stand-alone regulator.

Power supply Va (240) (Rail-A) is generated by a 6-phase buck converter (there are six SPSs—220-1 through 220-6), while power supply Vb (250) (Rail-B) is generated by a 3-phase buck converter (there are three SPSs—230-1 through 230-3). Nodes/Paths 240 and 250 can correspond to paths 112A and 112B of FIG. 1. Also shown in FIG. 2 are the switching nodes 221-1 to 221-6 of the corresponding power stages. In the interest of conciseness, other power supply circuits that generate supplies on paths 113, 114 and 115 are not shown in FIG. 2. The smart power stages will individually or collectively be referred by reference number 220/230, as will be clear from the context. Also, inductors 225A-1 through 225A-3 and 227B-1 through 227B-4 may be collectively or individually referred to by respective numerals 225 and 227, as will also be clear from the context. Similar convention is followed for other blocks/components/signals throughout the disclosure.

In an embodiment of the present disclosure, each of the power stages as well as the phase controller is implemented as separate integrated circuits (ICs). However, in other embodiments, the implementations of the power stages and phase controller may be different.

Phase controller 210 in conjunction with one or more power stages of a rail operates to generate a regulated voltage as output. In the example of FIG. 2, phase controller 210 and one or more of the power stages of Rail-A, namely SPSA-1 through SPSA-6, operate to generate regulated voltage Va (240). Similarly, phase controller 210 and one or more of the power stages of Rail-B, namely SPSB-1 through SPSB-3, operate to generate regulated voltage Vb (250). Accordingly, Va (240) and Vb (250) are shown as being provided as inputs to phase controller 210 to enable operation of one or more feedback loops within phase controller 210 to regulate voltages Va and Vb. Phase controller 210 also receives inductor-current information (regarding current IL, 290, flowing through each of the inductors 225) from each of the SPSs to enable various operations such as current-mode control of voltage regulation, current limiting, short-circuit protection, and balancing the currents generated by each SPS of a same converter (or ‘rail’) so as to make the currents from each SPS of a converter to be substantially equal in magnitude. The other signals flowing between phase controller 210 and the SPSs are described below.

The combination of (corresponding circuitry within) phase controller 210, an SPS and the corresponding inductor and capacitor forms one “phase” of a rail. Thus, for example, SPSA-1, inductor 225A-1, capacitor 226A-1, and the corresponding portion within phase controller 210 form a single buck converter, and one phase of the 6-phase buck converter. It is noted here that, while each phase is shown as having its own separate capacitor (e.g., 226A-1), in another embodiment, only a single larger capacitor (larger capacitance) may be employed at node 240 (as well as 250). In other embodiments, multiple capacitors are placed close to the load powered by the corresponding supply voltage.

It may be appreciated that the combination of phase controller 210 and one set of SPSes along with the external inductor, capacitor, etc., operates as a switching converter to provide a regulated output voltage. The term ‘switching converter’ as used herein includes a stand-alone switching converter (i.e., a non-multi-phase converter), a switching converter of a multi-phase voltage regulator or multi-phase regulator module having several independent switching converters, and also a portion of a switching converter, such as for example a smart power stage (SPS).

Phase controller 210 may be designed to implement automatic phase management (APM). Accordingly, the specific number of power stages (or phases) operated by phase controller 210 can vary depending, for example, on the magnitude of load-current drawn from a rail (e.g., Va 240). In general, the smaller the load-current is, fewer are the number of power stages used/operated and vice-versa.

As an example, for very low load-currents drawn from rail-A (Va 240) phase controller 210 may use/operate only one power stage (termed the ‘active’ power stage) to generate Va, and maintain the other five power stages in an ‘inactive’ state. Therefore, phase controller 210 generates the PWM signal to control switching of the high-side and low-side switches of only the one active power stage to generate Va, and maintain the PWM signals to the other five power stages in the Hi-Z state. Therefore, the high-side and low-side switches of those five inactive power stages would all be OFF (not switching).

Each SPS (or in general a ‘power stage’) may be implemented to contain a high-side switch, a low-side switch, gate drive circuitry for the two switches, a temperature monitor circuit and an inductor-current sense circuit/block to provide information indicating the magnitude of inductor-current (290) to phase controller 210. The current supplied by an SPS, and therefore the corresponding inductor current generally depends on the load-current drawn from the supply voltage, although the high-side switch and low-side switch of an SPS may be viewed as ‘driving’ the inductor. Under steady-state, the average inductor current equals the load-current in order to maintain the regulated output voltage at the desired magnitude. Each SPS receives a source of power (which can all be the same source) as an input which is connected to the high-side switch (shown in detail in sections below). In FIG. 2, the supply source is numbered 201, and has a voltage Vin. An example value of Vin in an embodiment of VRM 110 is about 12 volts (V). SPS 220 is also shown receiving voltage Vcc at power terminal 202.

Each SPS communicates with phase controller 210 via corresponding signals PWM, SYNC, CS and TEMP. Thus, SPSA-1 is shown connected to phase controller 210 through signal/paths PWMA-1 (211), SYNC-A (212), CSA-1 (213) and TEMPA (214). SPSA-6 communicates with phase controller 210 via signals PWMA-6, SYNC-A, CSA-6 and TEMPA (214), although in FIG. 2, the respective connections of signals PWMA-6, SYNC-A and CSA-6 to phase controller 210 are not shown. Similarly, SPSB-1 is shown connected to phase controller 210 through signal/paths PWMB-1 (216), SYNC-B (217), CSB-1 (218) and TEMPB (219). SPSB-3 communicates with phase controller 210 via signals PWMB-3, SYNC-B, CSB-3 and TEMPB (219), although in FIG. 2, the respective connections of signals PWMB-3, SYNC-A and CSB-3 to phase controller 210 are not shown. The other SPSs would have similar connections with phase controller 210.

Signal TEMP is an output (e.g., a voltage) from an SPS to phase controller 210, and provides information regarding the temperature in the SPS. Phase controller 210 may process the TEMP signal (or the information contained in it) to adjust the current supplied by that phase, or for shut-down of the VRM in the event of a fault indicating over-temperature condition. The TEMP outputs of each phase of a converter are wired together, and a single input (for e.g., TEMPA 214) is connected to phase controller 210. The maximum of the TEMP outputs of a phase is driven on the wired connection.

Signal SYNC is an input to an SPS and may be used by phase controller 210 for the purposes of waking-up the SPS upon power-up of the power supply 110, and also to indicate the power-mode (e.g., PS2, PS3), i.e., output current requirement, of the multi-phase converter. Typically, all SPSs of the same converter share a single SYNC signal (e.g., SYNC-A 212). Signal SYNC is set to the Hi-Z state to signal that the SPSes are to be shut down, i.e., all SPSes are to become inactive, and the corresponding power supply is not generated. In an embodiment, the Hi-Z state is a voltage level/band between the logic HIGH and logic LOW voltage levels of the SYNC signal. A ‘SYNC=Hi-Z’ condition is treated as a “chip disable” signal by internal state machines (not shown) in a power stage, and the state machines shut down all the other internal blocks in the power stage. A ‘SYNC=HIGH’ may be used for chip enable or chip reset. In embodiments described herein, SYNC=LOW us used to indicate DCM mode of operation of VRM 110.

Signal CS (current-sense) is an input to phase controller 210 from an SPS/phase, and contains information regarding the instantaneous magnitude of the inductor-current of that phase. The information can be in the form of a current, voltage, digital values, etc., depending on the specific implementation of the power stages and phase controller 210. A CS block in an SPS implements the current-sense operation and sends signal CS to phase controller 210.

In an embodiment of the present disclosure, the current-sense block of a power stage sends the sensed inductor-current information to phase controller 210 in the form of a current that can be of either the same magnitude as the inductor-current or (more typically) be a scaled-down version (in terms of magnitude) of the inductor-current. Correspondingly, in the embodiment, phase controller 210 is designed to receive the information in the form of a current, with the scaling factor being known to phase controller 210 as well as the (corresponding) power stage when scaling is used.

Signal PWM is an input to an SPS from phase controller 210, and may be viewed as a ‘phase control signal’ that controls the operation (ON and OFF states) of the power switches in the SPS of the corresponding phase. In an embodiment of the present disclosure, signal PWM is a pulse-width modulated (PWM) signal. Accordingly, in such an embodiment, signal PWM is a fixed-frequency, variable duty cycle signal. The duty cycle of the PWM signal is set by phase controller 210 and is designed to generate the desired power supply voltage and/or control/change the current supplied by that phase. For example, PWMA-1 (211) would have a duty cycle as required for the magnitude of Va (240) and the current to be provided by SPSA-1 (220-1). However, in general, signal PWM may have other characteristics depending on the specific implementation details of power supply 110.

For example, in another embodiment, phase controller 210 may employ a constant-ON-time control technique to generate Va. Accordingly, in such an embodiment, signal PWM is a variable frequency, fixed pulse-width (constant-ON-time) signal (i.e., pulse-frequency modulated signal, although the acronym PWM is still used herein to refer to such a signal for ease of reference). The frequency of the signal is generally proportional to the desired regulated voltage (Va) and the load-current. In yet another embodiment, signal PWM can change between a constant-ON time variable-frequency signal and a fixed-frequency pulse-width modulated signal, based on load-current requirements, desired efficiency of power supply 110 and other considerations, as would be apparent to one skilled in the relevant arts.

A PWM signal may be generated to have a logic HIGH state, a logic LOW state or a high-impedance (Hi-Z) state. Typically, the logic HIGH and logic LOW states of the PWM signal correspond respectively to the voltages (within error/noise margins) of the positive and negative rails of the power supply of the circuit generating the PWM signal, and the Hi-Z state corresponds to the mid-rail voltage of the power supply (or a voltage-window around the mid-rail voltage), as is well known in the relevant arts. However, other conventions can be employed for the three states of the PWM signal as would be apparent to one skilled in the relevant arts. Typically, the PWM signal needs to remain within the voltage-window noted above for a predetermined minimum duration for a power stage to correctly identify a Hi-Z state.

Signal PWM controls the opening and closing of the high-side switch and the low-side switch of a phase/power stage via the logic HIGH and logic LOW states. In an embodiment, a logic high level of PWMA-1 causes the high-side switch and the low-side switch in SPSA-1 to be respectively closed and open. A logic low level of PWMA-1 causes the high-side switch and the low-side switch in SPSA-1 to be respectively open and closed. Intervals in which HS switch is ON may be viewed as a ‘first phase’ (or ‘high-side phase’), and intervals in which LS switch is ON may be viewed as a ‘second phase’ (or ‘low-side phase’). The first and second phases repeat, and are thus periodic. The high-side switch and the low-side switch may be viewed as respectively ‘driving’ the inductor in each of the first phases and second phases periodically. It is noted that the terms ‘first phase’ and ‘second phase’ are not to be confused with the phases of a multi-phase converter (as noted above).

The Hi-Z state of the PWM signal indicates to the power stage that the power stage is not to operate in generating the output voltage, i.e., be ‘inactive’. Thus, when PWM is in the Hi-Z state, both the high-side and low-side switches of the stage are OFF, and the power stage can go to low-power/power-down modes. In general, phase controller 210 is designed to generate the PWM signal in a manner capable of indicating three states, with one of the three states indicating that the corresponding power stage is to be inactive. It will be apparent to one skilled in the relevant arts that such tri-state capability can be implemented in alternative ways. As an example, phase controller 210 can be implemented to generate PWM as a conventional binary signal with the power stages implemented to identify a Hi-Z state if the PWM signal is turned OFF, i.e., not generated at all.

The PWM signals to each SPS of a same converter may be staggered, i.e., delayed with respect to each other in phase such that typically no two high-side switches of a rail (i.e., in respective SPSs) are ON at the same time. Such a technique is employed for reasons such as, for example, to ensure that the peak instantaneous current drawn from Vin is relatively low at all times.

As is well known in the relevant arts, a switching converter is operable in one of the two modes—Continuous Conduction Mode (CCM) or Discontinuous Conduction Mode (DCM). CCM refers to a mode in which the inductor current flows continuously during the entire switching cycle. In CCM, the inductor current is allowed to go negative. The switching converter typically operates at a fixed frequency with variable duty cycle in CCM.

DCM refers to a mode in which the inductor current falls to zero during a portion of the switching cycle. In DCM, the inductor current is not allowed to go negative. The low-side switch is turned OFF when the inductor current becomes zero. This avoids reversal of inductor current (negative current), which would otherwise pull current out of the load. Thus, inductor current stays at zero until the high-side switch is turned ON in the next PWM cycle. In order to obtain the desired magnitude of load-current, the switching frequency is varied in DCM mode. For example, when constant-ON-time control technique is employed, the duration for which both the switches are OFF will be longer for a smaller load-current and vice-versa.

Typically, phase controller 210 operates the power stages in CCM for high load conditions, and in DCM for light load conditions. As used herein, ‘light load’ refers to the situation when the load presented at the output is a fraction (e.g., less than 10%) of the maximum rated power. Phase controller 210 may maintain only a small number of power stages in the active state when operating in DCM. Phase controller 210 operates the power stages in DCM for improved efficiency, as is well known in the relevant arts.

In an embodiment, in DCM, phase controller 210 maintains a single power stage in the active state, which is cycled over time for wear levelling. In other words, during operation in DCM with a single active power stage, the active power stage may be periodically changed (for example, from SPS-1 to SPS-2, etc.) based on techniques such as, for example, round-robin sequence, in order to distribute stress evenly among the power stages available to the rail.

It is noted herein that although the example illustration is described below with respect to multi-phase switching converter operating in DCM with only one active power stage, aspects of the present disclosure are equally applicable to a stand-alone switching converter, as will be apparent to a skilled practitioner by reading the disclosure herein.

In general, there are several recognized loss components such as switching loss (losses due to switching ON/OFF of power switches), conduction loss (voltage drop across the switches), dead-time loss (short between Vin and ground due to both power switches of a power stage being simultaneously ON), etc., that negatively impact the overall efficiency of a switching converter. Out of these, parasitic capacitances associated with the switches contribute significantly to some of the loss components such as switching loss, as described below.

Each of the high-side and low-side switches in SPS 220 is implemented as MOSFET (Metal Oxide Semiconductor Field Effect Transistor), and has associated parasitic capacitance as is well known in the relevant arts. In each cycle of PWM, as the voltage at SW node rises to Vin in the high-side phase, a charging current flows from the supply (Vin) to the corresponding parasitic capacitance via the high-side switch. In the low-side phase, as the voltage at SW node drops to zero the parasitic capacitance discharges to ground potential via the low-side switch. The charging and discharging of the parasitic capacitances via the corresponding switches lead to power loss. Such power/efficiency losses are undesirable, especially when the switching converter is operating under light load conditions.

The techniques of the present disclosure may improve the efficiency of the switching converter while also minimizing the incurred losses, and may be particularly advantageous when the switching converter is operating in DCM, in which the load-currents are usually low.

Several aspects of the present disclosure are directed to operation of a switching converter under light load conditions. The description is continued to illustrate an example implementation of a power stage according to aspects of the present disclosure.

### 4. Smart Power Stage (SPS)

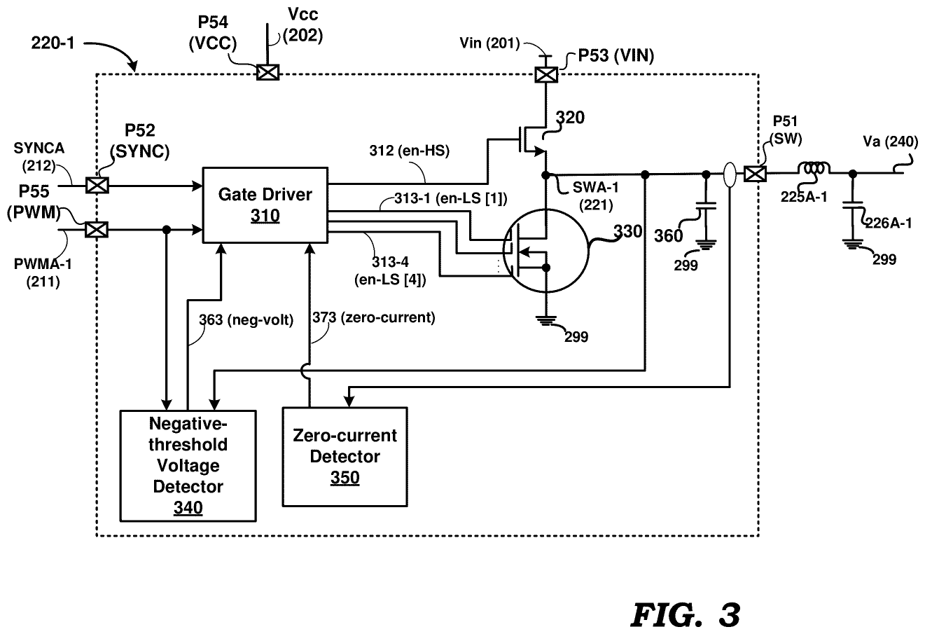

FIG. 3 is a block diagram illustrating the implementation details of a power stage in an embodiment of the present disclosure. SPSA-1 (220-1) is shown in detail in FIG. 3, and is assumed to the active power stage operating in DCM. The other SPSes can also be implemented to be similar to SPSA-1. SPSA-1 is shown containing gate driver 310, high-side (HS) switch 320, low-side (LS) switch 330, negative-threshold voltage detector 340 and zero-current detector 350. Also shown in FIG. 3 are inductor 225A-1, output capacitor 226A-1 and effective parasitic capacitor 360. P51 through P55 represent pins SW, SYNC, Vin, Vcc and PWM when power stage 220 is implemented as an integrated circuit (IC). In alternative implementations (e.g., in discrete form), P51 through P55 represent corresponding circuit nodes. Vcc (202) is used to power the internal blocks of power stage 220-1. The drain terminal of HS switch 320 is connected to Vin (201), and the source terminal of LS switch 330 is connected to ground. Although not shown in FIG. 3 in the interest of conciseness, power stage 220 may contain various other blocks/circuits such as level-converters for gate driver 310, temperature sensors, etc.

Capacitor 360 is a lumped representation of parasitic drain-to-source capacitances associated with HS switch 320 and LS switch 330. In other words, capacitor 360 represents an equivalent capacitance of a parallel combination of the parasitic capacitance present between drain and source terminals of HS switch 320 and the parasitic capacitance present between drain and source terminals of LS switch 330. Node 240 provides the supply voltage Va. Only components as relevant to the understanding of the disclosure are depicted in FIG. 3. It is understood that SPS 220-1 can contain more or fewer blocks than those shown in FIG. 3.

It is noted here that rather than a single block, two separate gate drivers may instead be employed—one for driving the gate of the HS switch to be ON or OFF, and another for driving the gate of the LS switch to be ON or OFF.

Gate driver 310 operates to generate drive signals en-HS 312 and en-LS 313-1 to 313-4 based on signal PWMA-1 (211) received from phase controller 210. Gate driver 310 determines whether or not SPS-1 is operating in DCM based on logic level of signal SYNCA (212). In an embodiment, when a logic LOW is received on path 212, gate driver 310 determines that SPS-1 is to be operated in DCM. Gate driver 310 is also shown receiving signals 363 (neg-volt) and 373 (zero-current), which will be described below in detail. Although the illustrative embodiment describes SYNC pin being used to communicate mode of operation (DCM/CCM) from phase controller 210 to SPS 220, the mode of operation can be transmitted in a convenient way from phase controller 210 to SPS 220 employing alternative techniques/pins, as will be apparent to a skilled practitioner by reading the disclosure herein.

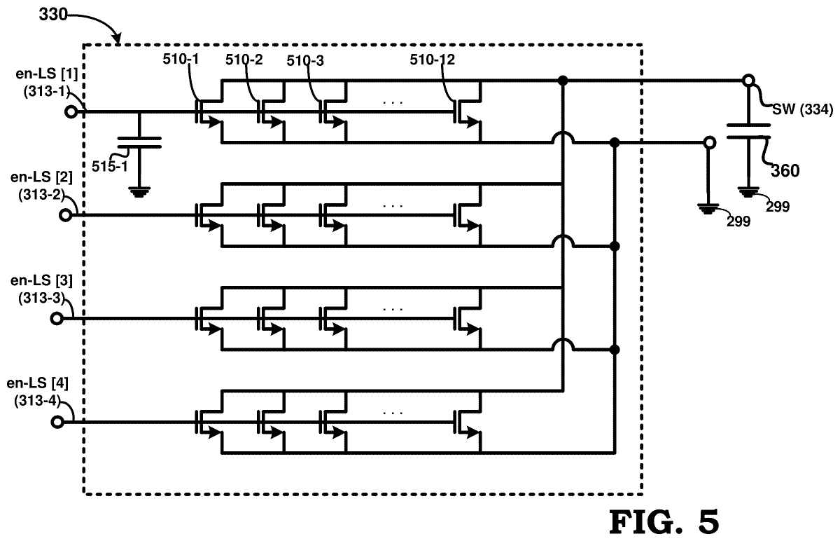

HS switch 320 is shown implemented as an N-channel MOSFET (Metal Oxide Semiconductor Field Effect Transistor). LS switch 330 is shown implemented as a multi-gate N-type enhancement MOSFET containing 4 independent gate terminals, and is described in further detail below with respect to FIG. 5.

It is noted herein that alternative implementations for the switches having similar characteristics can benefit from the features described herein. For example, LS switch 330 may have fewer or a greater number of independent gate terminals in alternative implementations, as will be apparent to a skilled practitioner by reading the disclosure herein.

Gate driver 310 drives the gate terminals of the MOSFETs. When PWMA-1 is a logic HIGH, gate driver 310 generates respective appropriate voltages on paths 312 (en-HS) and 313-1 to 313-4 (en-LS[1]-en-LS[4]) to switch-ON MOSFET 320 and switch-OFF MOSFET 330. When PWMA-1 is a logic LOW, gate driver 310 generates respective appropriate voltages on paths 312 and 313-1 to 313-4 to switch-OFF MOSFET 320 and switch-ON MOSFET 330.

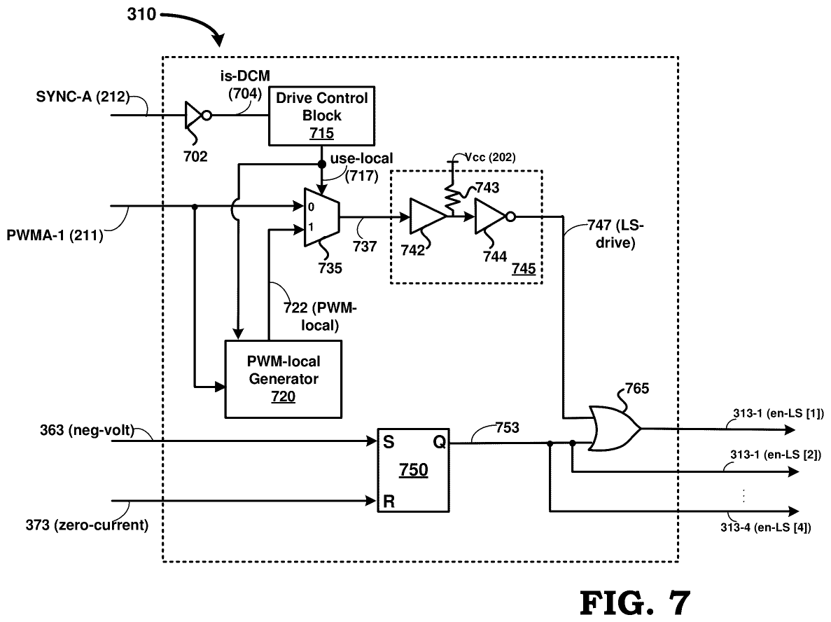

When PWMA-1 is in a Hi-Z (High-impedance or mid-rail) state, gate driver 310 generates the respective appropriate voltages on paths 312 and 313-1 to 313-4 to switch-OFF both of MOSFET 320 and 330. Gate driver 310 drives the switches with appropriate dead-time intervals to ensure that the HS and LS switches are never both ON in any interval to prevent short from Vin to ground (shoot-through condition), as is well known in the relevant arts. An example implementation of a gate driver block is described with reference to FIG. 7.

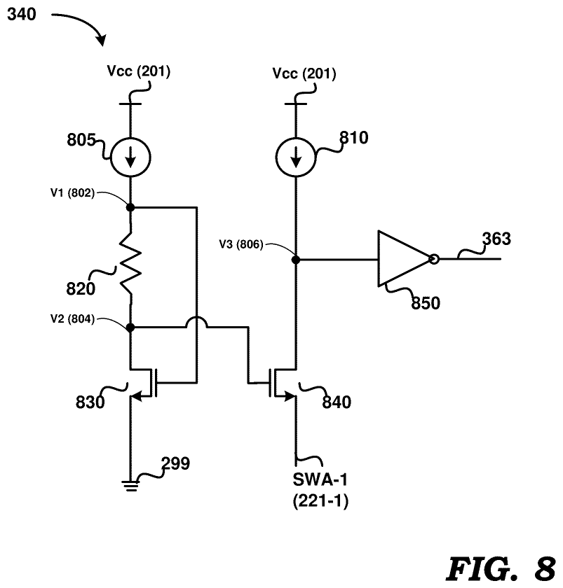

Negative-threshold voltage detector 340 operates to detect whether the voltage at ‘switching node’ SW-1 (221) has reached a negative (with respect to ground 299) threshold or not. Negative-threshold voltage detector 340 is shown connected to node SW-1 (221) as well as 211 (PWM-1). When PWM-1 is at Hi-Z, if negative-threshold voltage detector (340) detects that the voltage at SW-1 has reached the threshold, then negative-threshold voltage detector (340) asserts (for example, to logic HIGH) logic signal 363 (neg-volt) to indicate that voltage at node SW-1 has reached the threshold. When voltage SW-1 has not reached the threshold, negative-threshold voltage detector (340) de-asserts neg-volt (363). When PWM-1 is not at Hi-Z, negative-threshold voltage detector (340) maintains neg-volt (363) in the de-asserted state. An example implementation of negative-threshold voltage detector is described with respect to FIG. 8.

Zero-current detector 350 operates to detect whether current through the inductor associated with the power stage is zero or not. Zero-current detector (350) is shown receiving magnitude of inductor current. If zero-current detector (350) detects that the inductor current is zero, then zero-current detector (350) asserts (for example, to logic HIGH) logic signal 373 (zero-current). Otherwise, zero-current detector (350) maintains signal 373 in the de-asserted state. Zero-current detector (350) may be implemented in a known way.

When HS switch 320 is ON, current flows from Vin to the load (connected to Va node) via HS switch 320 and inductor 225A-1 associated with SPSA-1 (220-1) with rising slope. Voltage at SW node (221) rises to Vin (201). When LS switch 330 is ON, the inductor current flows in the loop formed by LS switch 330, inductor 225A-1 and load with falling slope. Voltage at SW node (221) falls to zero Volts. One period of PWMA-1 signal may be referred to as a ‘cycle’ of operation of an SPS or switching converter in general. Thus, in each cycle of PWM (211), effective parasitic capacitor (360) charges towards Vin via HS switch 320 (when HS switch 320 is ON) by drawing corresponding current from supply Vin, and discharges towards zero Volts via LS switch 330 (when LS switch 330 is ON).

Each time capacitor 360 is charged (or discharged) via either of the switches, there is a corresponding power loss equal to:

$$PL 1 = 1 / 2 * Cpar * {Vc}^{2} * f - sw \qquad equation ( 1 )$$

where: Cpar is the capacitance of effective parasitic capacitor 360, Vc is the change in voltage across capacitor 360 during the charging (or discharging) via either of switches, and f-sw is the switching frequency of signal PWM.

In addition, charging and discharging of effective parasitic capacitor 360 via the switches results in I²*R loss (R-ON loss) due to ON-resistance of the corresponding switch, as is well known in the relevant arts. The loss may be minimized by charging/discharging parasitic capacitor 360 (at least partially) via inductor (225-1) instead of via the switches. This is so because with all else being the same, inductor core losses are lesser in magnitude than R-ON losses if capacitor 360 were to be charged via the switches, as is well known in the relevant arts.

Such power losses noted above result in decreased efficiency of the switching converter. Though the losses are incurred both in CCM and DCM, in DCM, the load itself is much smaller and therefore the same loss would become a more significant proportion of the load. Therefore, the losses become more significant in DCM.

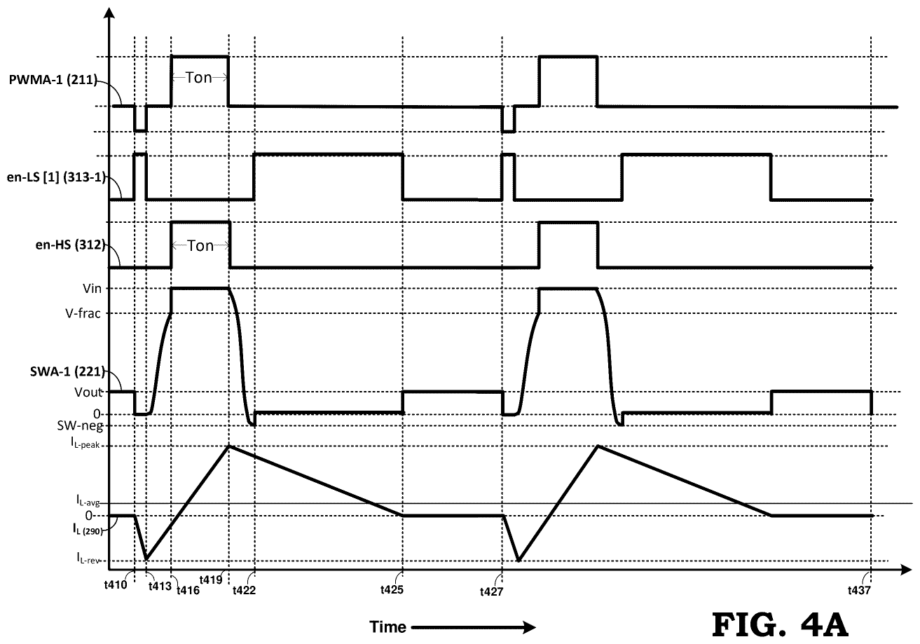

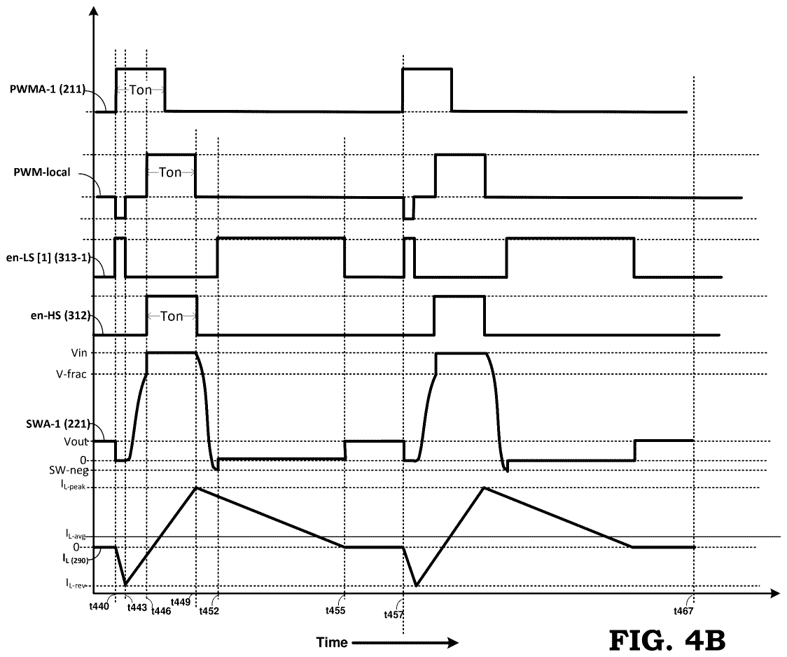

According to aspects of the present disclosure, in DCM, just prior to turning ON HS switch 320 in each PWM cycle, capacitor 360 is charged efficiently to a desired fraction of Vin (201) instead of all the way to Vin, in order to minimize losses. By charging capacitor to the desired fraction prior to turning ON of HS switch, charging of capacitor 360 via HS switch is minimized, thereby reducing losses. LS switch 330 is turned ON briefly at the start of each cycle of PWM (211) for enabling the above noted condition, as described next with respect to FIG. 4A while referring back to FIG. 3 as applicable.

### 5. Reducing Losses in a Power Stage in DCM

FIG. 4A is a timing diagram (not to scale) illustrating example waveforms of some signals/nodes of an SPS (e.g., SPS-1 of FIG. 3) in an embodiment of the present disclosure. SPS-1 is assumed to the only active power stage operating in DCM. FIG. 4A depicts example waveforms of signals PWMA-1 (211), en-LS [1](313-1), en-HS (312), voltage at node SWA-1 (221), and current IL (290) through inductor 225A-1. Time intervals t410-t427 and t427-t437 depict two PWM cycles (i.e., cycles of signal PWM-1 (211-1)). IL-avg represents the average inductor current over the two cycles.

In an embodiment, each PWM cycle in DCM includes the following durations (in chronological order):
1. A first LS-phase in which LS switch 330 is ON and HS switch 320 is OFF;
2. An HS-phase (of duration T-ON) in which HS switch 320 is OFF and LS switch 330 is ON;
3. A second LS-phase in which LS switch 330 is ON and HS switch 320 is OFF; and
4. An idle-phase in which both the switches are OFF and inductor current is zero.

As noted above, the switches are operated with corresponding ‘dead-time’ intervals between durations (1) and (2) (hereafter “first dead-time interval”), and between durations (2) and (3) (hereafter “second dead-time interval”).

According to an aspect of the present disclosure, the durations of the first LS-phase duration (hereafter T-off-1) and the first dead-time interval (hereafter T-deadtime-1) may be configured to be computed either by phase controller 210 or by SPS 220. The magnitude of T-ON duration is always provided by phase controller 210 to SPS 220 on path 211. In an embodiment, the configuration data is burnt in an OTP bit in a non-volatile memory of SPS 220 (as well as phase controller 210). For example, a value of ‘0’ (‘1’) in the NVM bit of SPS (‘phase controller’) indicates that SPS is operable to use PWMA signal received from phase controller 210 for T-off-1 and T-deadtime-1, while a value of ‘1’ (‘0’) in the bit indicates that SPS is operable to compute the noted durations. Phase controller 210 and SPS 220 read the configuration bit from the respective NVMs in a known way and generate PWMA/gate drive signals based on the configuration bit.

In the illustrative embodiment (first embodiment) of FIG. 4A, it is assumed that phase controller 210 is configured to generate PWMA on path 211 indicating magnitude of T-off-1 and T-deadtime-1 durations (in addition to magnitude of T-ON duration). In an alternative embodiment (second embodiment), SPS 220 computes the magnitudes of T-off-1 and T-deadtime-1, and phase controller 210 specifies the magnitude of T-ON duration. PWMA signal 211 generated for the first and second embodiments is depicted in FIGS. 4A and 4B respectively. Signal PWM-local depicted in FIG. 4B is the signal generated local (internal) to SPS 220, and is explained in further detail below with respect to FIG. 7.

According to an aspect of the present disclosure, durations T-off-1 and T-deadtime-1 are pre-computed with corresponding magnitudes such that by the time instance of turning ON HS switch 320 (2), the voltage across capacitor 360 reaches the desired fraction of Vin. In addition, in the first LS-phase, only a portion of LS switch 330 is turned ON in order to reduce the losses incurred due to charging of gate capacitance of LS switch. In an embodiment, only ¼^{th} of LS switch 330 is turned ON in the first LS-phase. The manner in which such switching may minimize losses and improve efficiency is described in detail next with respect to FIG. 4A.

Just prior to t410, PWMA-1 is shown to be at Hi-Z. Thus, just prior to t410, en-LS and en-HS are at logic LOW and current IL (250) equals zero. Accordingly, referring to FIG. 3, with both switches being OFF and no current flowing through inductor 225A-1, voltage at SW-1 as well as voltage across capacitor 360 is of magnitude Va.

At t410 (start of a new PWM cycle in DCM), gate driver 310 receives a logic LOW on path 211 and in response, generates logic LOW on path en-HS, thus maintaining HS switch 320 in OFF state. Gate driver 310 detects transition of signal PWMA-1 from Hi-Z to logic LOW and accordingly, generates logic HIGH on path 313-1 and logic LOW on paths 313-2 to 313-4 (not shown in FIG. 4A), thus turning ON ¼^{th} of LS switch 330. Time duration t410-t413 corresponds to the first LS-phase noted above.

When LS switch 330 is turned ON, voltage at SWA-1 falls to zero Volts, and capacitor 360 begins to discharge via LS switch. Inductor current IL starts flowing from load (Va) to SWA-1. As noted above, phase controller 210 pre-computes the duration (t410-t413) of the first LS-phase, and accordingly generates PWMA-1 at logic LOW for the pre-computed duration. The pre-computed duration is designed such that the negative inductor current reaches a pre-determined magnitude by the end of the first LS-phase, as will be described in detail in sections below. Thus, inductor current is shown reaching pre-determined magnitude ‘IL-rev’ by t413.

At t413, gate driver 310 receives Hi-Z on path 211 and in response, generates logic LOW on path en-LS [1], thus turning OFF LS switch 330. Gate driver 310 continues to maintain HS switch 320 in OFF state. When LS switch is turned OFF, the (negative) inductor current charges capacitor 360 via inductor 225A-1. Thus, voltage at SWA-1 node starts rising from zero Volt towards Vin.

It may be observed that the charging current is drawn from inductor 225A-1, and during this charging interval (t413-t416), the inductor core losses may also contribute to overall efficiency loss of the switching converter. To minimize the inductor core loss, the magnitude of maximum inductor current (I-rev) in the first LS-phase should be as small as possible while at the same time enabling to make the power loss via parasitic capacitor 360 (PL1 of equation (1)) non-dominant by sufficiently charging parasitic capacitor 360. If capacitor 360 were to be charged all the way to Vin (instead of V-frac), the loss incurred due to inductor core loss may outweigh the benefit accrued by reducing the power loss due to charging of parasitic capacitance via HS switch.

Accordingly, inductor current in the first LS-phase may be allowed to only reach a magnitude (I-rev) so as to take the voltage at SWA-1 (as well as voltage across capacitor 360) to a desired fraction of Vin (but not all the way to Vin) by the time HS switch is turned ON (at t416). The magnitude of voltage corresponding to the desired fraction is depicted as V-frac in FIG. 4A. In an embodiment, the desired fraction is 0.75. Thus, if Vin equals 12 V, then V-frac equals 9 V. Although the illustrative embodiment depicts a fraction of 0.75, in general, a value from a range of fractions (e.g., >=0.4 to some small fraction less than 1.0) may be configured for V-frac.

At t416, gate driver 310 receives logic HIGH on path 211 and in response, generates logic HIGH on path en-HS, thereby turning ON HS switch. Gate driver 310 maintains LS switch in OFF state. When HS switch is turned ON, voltage at SWA-1 rises to Vin, and current flows from Vin to the load via HS switch 320 and inductor 225A-1 with rising slope, and attaining value IL-peak by t419. Thus, capacitor 360 charges from voltage V-frac to Vin via HS switch. Time duration t416-t419 corresponds to the HS-phase noted above.

Duration T-ON of HS-phase may be of a fixed width in case of constant-ON-time control technique noted above, with PWM frequency being proportional to the desired regulated voltage (Va) and the load-current. In alternative embodiments employing fixed-frequency, variable duty cycle signal, T-ON duration may vary based on magnitude of Va and the load-current. For example, higher the load-current requirement, larger is the T-ON duration and vice versa.

Referring to equation (1), it may be appreciated that by charging capacitor to V-frac prior to turning ON HS switch, Vc equals (Vin minus V-frac), thereby significantly reducing power loss due to charging of parasitic capacitor 360 via HS switch.

Assuming example values of Vin=12 V, Va=1 V, Cpar=3.3 nano-Farads (nF), f-sw=50 kilo Hertz (Hz), had capacitor 360 been charged from zero to Vin V via HS switch (i.e., without the invention), power loss would have been:

$$PL 1 ( without ) = 3.3 nF * {( 12 - 0 )}^{2} * 50 kHz = 23.76 milli Watts ( mW )$$

With the invention, capacitor charges only from V-frac to Vin via HS switch. Therefore, power loss equals:

$$PL 1 ( with ) = 3.3 nF * {( 12 - 9 )}^{2} * 50 kHz = 0.66 mW$$

Thus, power loss due to parasitic capacitor is reduced to 1/35^{th} of the value without the invention, thus making such loss non-dominant.

At t419, gate driver 310 receives Hi-Z on path 211, and in response, generates logic LOW on path en-HS, thus turning OFF HS switch 320. LS switch continues to be OFF for the duration of dead-time. When HS switch is turned OFF, voltage at SWA-1 starts falling from Vin towards zero V. Capacitor 360 starts discharging (from Vin) in order to keep current through inductor 225A-1 flowing from Vin to the load. Accordingly, starting at t419, inductor current is shown with falling slope.

With both the switches OFF, and assuming that the dead-time duration is long enough, capacitor 360 completely discharges, and the inductor will try to maintain its current, pulling the switching node negative until the low-side MOSFET's body-diode conducts. When the voltage SWA-1 becomes less than the cut-in voltage (SW-neg in FIG. 4A, around 0.7 volt (V) in the embodiment) of the body-diode (between source and drain) of the LS switch, inductor current flows via the body-diode. The conduction of current through body-diode of LS switch is described in further detail below with reference to FIG. 5.

With PWM at Hi-Z and voltage at SWA-1 reaching the negative threshold, negative-threshold voltage detector 340 asserts signal 363 (not shown in FIG. 4A) at t422. In response to assertion of signal 363, gate driver 310 generates logic HIGH on paths en-LS [1]-en-LS [4], thereby turning ON LS switch (fully). Only en-LS [1] is shown in FIG. 4A in the interest of conciseness. Though not shown in FIG. 4A, gate driver 310 generates logic HIGH on paths 313-2 to 313-4 also.

At t422, when LS switch is turned ON, voltage at SWA-1 rises to zero V. Inductor current flows via LS switch with falling slope until it reaches zero at t425.

At t425, zero-current detector 350 asserts signal 373 (not shown in FIG. 4A). In response, gate driver 310 generates logic LOW on paths en-LS [1]-en-LS [4], thereby turning OFF LS switch. Time duration t422-t425 corresponds to the second LS-phase noted above.

When LS switch is turned OFF, voltage at SWA-1 (as well as voltage across capacitor) rises to Va, and stays at Va until the next PWM cycle starts at t427. Duration t425-t427 corresponds to the idle-phase noted above.

FIG. 4B is a timing diagram (not to scale) illustrating example waveforms of some signals of an SPS (e.g., SPS-1 of FIG. 3) in an alternative embodiment of the present disclosure. In the alternative embodiment, it is assumed that SPS 220 computes magnitudes of T-off-1 and T-deadtime-1, and receives the magnitude of T-ON duration from phase controller 210 on path 211. SPS 220 thus derives signal PWM-local from PWMA-1 received on path 211 in order to drive the switches.

Time intervals t440-t457 and t457-t467 depict two PWM cycles (i.e., cycles of signal PWMA-1 (211)). Signals en-LS [1], en-HS, voltage at SW node (221) and inductor current waveforms correspond to those depicted in FIG. 4A, and their description is not repeated here in the interest of brevity. SPS 220 generates signal PWM-local identical to PWMA-1 of FIG. 4A (representing PWM signal 211 received from phase controller 210 if phase controller were to compute magnitudes of T-off-1 and T-deadtime-1).

The description is continued to illustrate an example implementation of LS switch 330 in an embodiment of the present disclosure.

### 6. Example Implementation of Low-Side Switch

FIG. 5 is a diagram illustrating the implementation of a low-side switch in an embodiment of the present disclosure. LS switch 330 is shown in detail in FIG. 5. LS switch 330 is shown implemented as N-type enhancement multi-gate MOSFET. In an embodiment, LS switch 330 contains 4 sections, with each section containing 12 transistors, with the transistors arranged in parallel. Only transistors in the first (topmost) section have been numbered (510-1 to 510-12) in the interest of conciseness. The drain terminals of all transistors of all sections are tied together. Similarly, the source terminals of all transistors of all sections are tied together. The gate terminals of all transistors in each section are tied together, with a respective independent gate terminal for each section. Although the illustrative embodiment depicts 4 sections of 12 transistors each, in alternative implementations, LS switch 330 may be designed to contain any appropriate number of sections/transistors (based on factors such as chip area constraints/Vin/Va/maximum rated power of VRM 110, etc.), as will be apparent to a skilled practitioner by reading the disclosure herein.

Each section is shown receiving a corresponding gate drive signal en-LS (313). Accordingly, 4 drive signals en-LS [1](313-1) to en-LS [4](313-4) are shown in the Figure. Also shown in FIG. 5 is capacitor 360 (of FIG. 3) and effective parasitic gate capacitor 515-1. Capacitor 515-1 represents an equivalent capacitance of a combination of parasitic capacitances that are present between the gate and drain of each of transistors 510-1 to 510-12. Though not shown in the Figure in the interest of brevity, similar effective parasitic gate capacitance would be present between gate and drain terminals of transistors contained in the other sections as well. Also, though not shown in FIG. 5, body-diode is present between source and drain terminals of each transistor of LS switch.

In an embodiment, when en-LS [x] for a particular section is a logic HIGH, all transistors contained in that section are turned ON, and when en-LS [x] for a particular section is a logic LOW, all transistors contained in that section are turned OFF. Thus, if en-LS [1] is a logic HIGH, transistors 510-1 to 510-12 are turned ON while if en-LS [1] is a logic LOW, transistors 510-1 to 510-12 are turned OFF.

As is well known in the relevant arts, LS switch is typically quite large, and therefore charging of the parasitic gate capacitances each time LS switch is turned ON contributes to power loss. Referring back to FIGS. 4A/4B, it is noted that LS switch is turned ON twice in each PWM cycle, thereby resulting in loss due to the additional LS-phase (i.e., the first LS-phase, which would not have been present in the PWM cycle without the invention). Therefore, according to an aspect of the present disclosure, in the first LS-phase (time duration t410-t413 of FIG. 4A and time duration t440-443 of FIG. 4B), only a portion of the switch is turned ON, thereby proportionally reducing the parasitic gate capacitance (and therefore the additional loss noted above). In an embodiment, only ¼^{th} of LS switch 330 is turned ON in the first low-side phase.

It may be appreciated that due to turning on a portion of LS switch 330, the ON-resistance of the switch is higher in magnitude as compared to ON-resistance when the switch is fully turned ON (all sections turned ON), thus resulting in higher I²*R loss. However, parasitic gate capacitance is lower in magnitude when a portion of the switch is turned ON, thus resulting in lower switching loss. The fraction of LS switch 330 to be turned ON therefore is designed such that an optimal trade-off between I²*R loss and switching loss (due to gate capacitance) is achieved, as will be apparent to a skilled practitioner by reading the disclosure herein.

The description is continued to illustrate an example implementation of a phase controller in an embodiment of the present disclosure.

### 7. Phase Controller

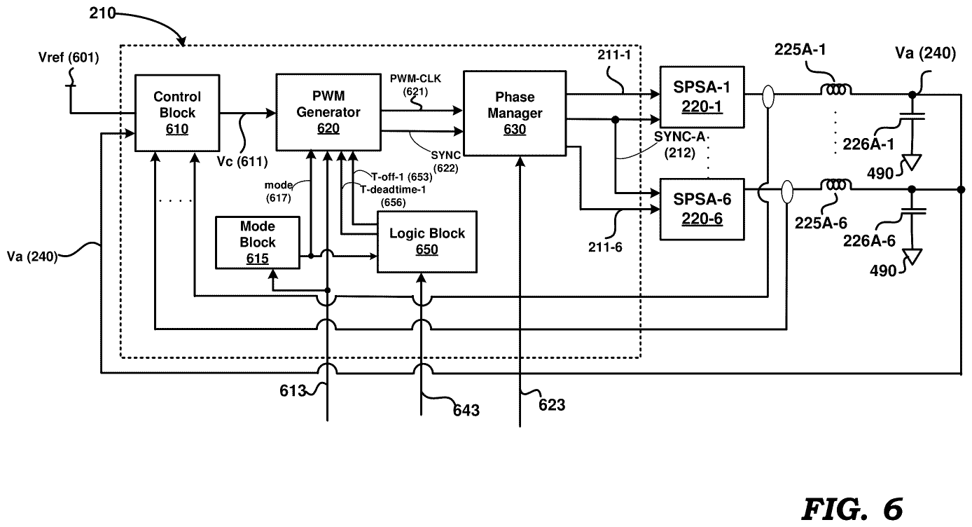

FIG. 6 is a diagram illustrating the implementation details of a phase controller in an embodiment of the present disclosure. Phase controller 210 is shown as containing control block 610, mode block 615, PWM generator 620, phase manager 630, and logic block 650. Also shown in the Figure for the purpose of ease of understanding and clarity are the power stages 220-1 through 220-6, and the corresponding inductors and capacitors. Only the 6-phase converter containing power stages SPSA-1 (220-1) through SPSA-6 (220-6) together generating voltage Va (240) is depicted in FIG. 6 for ease of understanding.

Also, it is noted herein that only components as relevant to the understanding of the disclosure are depicted in FIG. 6. It is understood that phase controller 210 can contain more or fewer blocks than those shown in FIG. 6. Further, phase controller 210 is described and illustrated as employing current-mode control technique merely for illustration. However, it must be understood that phase controller 210 can employ other types of control techniques. The internal blocks of phase controller 210 may be powered by a source, not shown.

Vref represents the desired target voltage to be supplied at node Va (240). Thus, Vref represents a stable reference DC voltage which is generated internally in phase controller 210 in a known way. Control block 610 receives reference voltage Vref (601), output voltage, Va (240) (or alternatively, some fraction of Va using a voltage divider network) and generates voltage Vc (611) representing the difference between voltages Vref (601) and Va (240), that forms one input to PWM generator 620. Control block 610 may internally contain components such as an error amplifier, a proportional-integral-derivative controller, etc., as is well known in the relevant arts. Control block 610 may be implemented in a known way.

Mode block 615 receives load-current information on path 613, and generates signal ‘mode’ on path 617 indicating whether SPS(s) are to be operated in CCM or DCM. In an embodiment, mode block 615 generates logic HIGH on path 617 if load-current is less than a pre-determined threshold magnitude, and a logic LOW otherwise. The threshold may either be pre-programmed in non-volatile memory in phase controller 210 or may be received as user input via corresponding means (not shown). In the embodiment, the pre-determined threshold represents a value equaling less than 10% of the maximum rated current. As an example, if the maximum rated current is 100 Amperes (A), then the pre-determined threshold equals 10 A. Mode block 615 may be implemented in a known way.

PWM generator 620 generates signal PWM-CLK (621) and signal SYNC (622) based on signal Vc (611), load-current requirement received on path 613 and signal mode received on path 617. Though not shown in FIG. 6, PWM generator 620 may additionally receive feedback signals (e.g., sensed inductor-currents, instantaneous magnitude of output voltage Va, etc.) to determine the periodicity (or frequency) and pulse-width of signal PWM-CLK, as is well known in the relevant arts. Thus, blocks/components 610 and 620 together operate to generate PWM-CLK such that voltage Va (240) is maintained at the desired magnitude as indicated by Vref (601). PWM generator 620 is also shown receiving signals T-off-1 (653) and T-deadtime-1 (656), which will be described below in detail.

PWM generator 620 generates signal SYNC based on signal mode (617). In an embodiment, when a logic HIGH is received on path 617 (indicating DCM), PWM generator generates a logic LOW on path 622 (SYNC). In DCM, as noted above, a configuration bit in NVM of phase controller 210 indicates whether or not phase controller 210 is to compute magnitudes of T-off-1 and T-deadtime-1. PWM generator 620 reads the configuration bit from the NVM in a known way and generates signal PWM-CLK based on the configuration bit. Alternatively, mode block 615 may read the configuration bit and send the information to PWM generator 620 via corresponding path (not shown).

Specifically, when the configuration bit indicates (e.g., value ‘0’) that phase controller 210 need not compute the magnitudes of T-off-1 and T-deadtime-1, phase controller 210 disregards inputs received on path 653 and 656, and generates PWM-CLK based only on input 613. In such an embodiment, PWM generator 620 toggles PWM-CLK between HIGH and Hi-Z states, with the duration of HIGH supporting the load-current requirement. Thus, PWM generator generates each cycle of PWM waveform (signal PWMA-1 of FIG. 4B) on path 621 as follows:
A logic HIGH with a duration determined based on input 613
Hi-Z for the rest of the cycle.

In an alternative embodiment, when the configuration bit indicates (e.g., value ‘1’) that phase controller 210 is to compute the magnitudes of T-off-1 and T-deadtime-1, phase controller 210 generates PWM-CLK based on signals 653 and 656, in addition to input 613. In the alternative embodiment, PWM generator 620 toggles PWM-CLK between LOW, HIGH and Hi-Z states. Thus, PWM generator generates each cycle of PWM waveform (signal PWMA-1 of FIG. 4A) on path 621 as follows:
A logic LOW with a duration magnitude equal to the value received on path 653
Hi-Z with a duration magnitude equal to the value received on path 656
HIGH with a duration magnitude determined based on input 613
Hi-Z for the rest of the cycle.

PWM generator may internally contain components (not shown in FIG. 6) such as sawtooth waveform generator, timers, comparators, etc. required to generate signal PWM-CLK, as is also well known in the relevant arts. PWM generator may be implemented in a known way.

Phase manager 630 controls the addition or shedding of phases (and therefore power stages) based on values received on path 623 (e.g., load-current requirement, changes in Vin/Va, etc.) and the logic level of signal SYNC received on path 622. In an embodiment, phase manger operates a single power stage in active state when a logic LOW is received on path 622 (i.e., DCM). Phase manager staggers the PWM signals to each active SPS in CCM. Phase manager operates to activate power stages in a round-robin fashion for wear leveling as noted above.

Phase manager forwards signal PWM-CLK (621) on path(s) 211 corresponding to the active power stage(s). Thus, in CCM, phase manager forwards signal PWM-CLK (621) on multiple paths corresponding to the active power stages. Phase manager also forwards signal SYNC (622) to all power stages (SPS-1 to SPS-6) on path 212. Phase manager may be implemented in a known way.

Logic block 650 generates signals T-off-1 (653) and T-deadtime-1 (656). Logic block 650 reads the above noted configuration bit from the NVM in a known way. Logic block 650 performs the computations of magnitudes of T-off-1 and T-deadtime-1 only when the configuration bit indicates that phase controller 210 needs to compute the magnitudes of T-off-1 and T-deadtime-1, and signal mode (617) is a logic HIGH. Logic block 650 performs the computations based on input(s) received on path 643 representing magnitude of voltage Va (240), desired voltage magnitude (either as a direct value or as a fraction of Vin) to be developed across parasitic capacitor 360 just prior to turning ON HS switch, capacitance value of parasitic capacitor 360, inductance value of inductor 225, Vin, etc. The values on path 643 may either be pre-programmed in phase controller 210 or received as user input. The manner in which logic block 650 computes magnitudes of T-off-1 and T-deadtime-1 in an embodiment of the present disclosure is described next.

Referring back to FIG. 3, for capacitor 360 to be charged to V-frac by t416, energy built in inductor 225 in the first LS-phase duration needs to be transferred to capacitor 360 in the first dead-time interval. Thus, logic block 650 computes magnitude of I-rev using the equation:

$$0.5 * L * {i}^{2} = 0.5 * C * {V}^{2} \qquad equation ( 2 )$$

In the first dead-time interval:

$$0 \text{.5} * L * I - re {v}^{2} = 0.5 * Cpar * V - fra {c}^{2}$$

where: L is the inductance value of 225 (of the active power stage in DCM, which is typically the same for all power stages in a VRM), I-rev and V-frac correspond to magnitudes shown in FIGS. 4A/4B. Values of L, Cpar and V-frac are received on path 643. Accordingly, logic block 650 computes the magnitude of I-rev.

Referring back to FIG. 4, it may be noted that in the first LS-phase, voltage at SWA node falls from Va to zero V, while inductor current builds from zero to I-rev Amperes. Thus, logic block 650 computes magnitude of T-off-1 using the equation:

$$v = L ( di / dt ) \qquad equation ( 3 )$$

In the first LS-phase, (0 minus Va)/L=di/dt.

Values of Va and L are received on path 643. ‘di’ equals (I-rev minus 0), where I-rev is computed from equation (2) above. Accordingly, logic block 650 computes the magnitude of T-off-1.

Since the change in voltage across capacitor 360 and the corresponding amount of energy is known, logic block 650 computes the magnitude of T-deadtime-1. Alternatively, HS switch 320 may be turned ON when voltage at SW node reaches V-frac magnitude post first LS-phase. In general, the dead-time duration should be sufficiently long enough to charge capacitor 360 to V-frac by t416 (before turn-ON of HS switch 320).

As noted above, the magnitude of V-frac may be selected such that an optimal trade-off between inductor core losses and power loss due to parasitic capacitor (360) is achieved, as will be apparent to a skilled practitioner by reading the disclosure herein. It may be appreciated that the magnitude of V-frac and the minimum peak value of inductor current (I-rev) that needs to be built in the first LS-phase are inter-dependent. A small value of I-rev may not provide enough charge to charge capacitor 360 to the desired voltage V-frac, while a large value of I-rev may result in higher inductor core losses noted above.

The description is continued to illustrate an example implementation of a gate driver in an embodiment of the present disclosure.

### 8. Gate Driver Block

FIG. 7 is a diagram illustrating the implementation details of a gate driver block of a power stage in an embodiment of the present disclosure. Gate driver 310 is shown containing inverter 702, drive control block 715, PWM-local generator 720, multiplexer (MUX) 735, PWM level converter 745, SR-latch 750 and OR gate 765. PWM level converter 745 in turn is shown containing buffer 742, resistor 743 and inverter 744. Only components as relevant to the understanding of the disclosure are depicted in the Figure. It is understood that gate driver 310 can contain more or fewer blocks than those shown in FIG. 7.

It is noted herein that the Figure depicts generation of drive signals en-LS [1]-en-LS [4] for LS switch 330 only. Gate driver 310 generates drive signal en-HS in a known way.

Specifically, gate driver 310 maintains a logic HIGH on path en-HS for the duration T-ON specified on path 211.

Drive control block 715 generates signal ‘use-local’ on path 717 based on signal is-DCM received on path 704. As noted above, in DCM, SPS 220 may be configured to either compute magnitudes of T-off-1 and T-deadtime-1, or receive the magnitudes of the durations from phase controller 210 on path 211. Drive control block 715 reads the configuration bit from the NVM of SPS 220 in a known way and generates signal use-local based on the configuration bit. When a logic LOW is received on path 704 (i.e., CCM), drive control block generates a logic LOW on path 717 (disregarding the OTP bit). When a logic HIGH is received on path 704, drive control block generates a logic HIGH on path 717 if the OTP bit is set to ‘1’, and a logic LOW otherwise. Drive control block 715 may be implemented in a known way.

PWM-local generator 720 generates PWM waveform on path 722 (PWM-local) based on signal PWMA (211) and signal use-local received on path 717. Signal 722 corresponds to signal PWM-local depicted in FIG. 4B.

When a logic HIGH is received on path ‘use-local’, block 720 computes the magnitudes of T-off-1 and T-deadtime-1 as described above. Of the values that are required to perform the computations, the real-time magnitudes of Va and Vin may be obtained from corresponding nodes, and the values of L, Cpar, V-frac, etc. may be read from NVM or may be received as user input via corresponding means not shown. Block 720 computes the magnitudes once (for example, the first time signal use-local is HIGH after power-on), stores the computed values in registers (not shown) and thereafter uses the stored values to generate control signal waveform on path 722. Alternatively, block 720 may employ closed-loop control in order to generate signal PWM-local such as for example, monitoring voltage at SW node post the first LS-phase. Although not shown in FIG. 7, block 720 may internally contain components such as timers, counters, comparators, etc. in order to generate signal on path 722, as will be apparent to a skilled practitioner by reading the disclosure herein. An example functional implementation of block 720 is described below.

When operating in DCM, if gate driver 310 is configured to compute magnitudes of T-off-1 and T-deadtime-1 local to SPS 220, then signal PWMA received from phase controller 210 on path 211 toggles between logic HIGH and Hi-Z states, with the duration of each state as determined by the load-current requirement. In each cycle of PWMA (211), when a rising edge (start of T-ON) is received on path 211, block 720 starts a first timer for the pre-computed duration magnitude T-off-1, and generates corresponding falling edge (logic LOW) of PWM-local (start of first LS-phase). At the end of the first timer duration (end of first LS-phase), block 720 starts a second timer for the pre-computed duration magnitude T-deadtime-1, and transitions PWM-local from LOW to Hi-Z. At the end of the second timer duration (end of first dead-time interval), block 720 transitions PWM-local from Hi-Z to HIGH (i.e., generates rising edge of PWM-local).

It may be appreciated that block 720 maintains logic HIGH on PWM-local for the T-ON duration magnitude received on path 211. Accordingly, a suitable logic block may be employed to measure T-ON duration magnitude, and block 720 transitions PWM-local from HIGH to Hi-Z based on the measured value. Block 720 maintains Hi-Z state until the next rising edge (start of next cycle) of PWMA is received on path 211. Thus, block 720 generates signal PWM-local identical to PWMA-1 of FIG. 4A (representing PWM signal received from phase controller 210 if phase controller 210 were to compute magnitudes T-off-1 and T-deadtime-1 in DCM).

MUX 735 receives signal PWMA on path 211 and PWM-local on path 722 as inputs, and forwards one of signals 211 and 722 on path 737 as an output (MUX output 737) based on the logic value of select signal 717 (use-local). In an embodiment, when signal use-local (717) is a logic HIGH, signal 722 is selected as MUX output on path 737, while when signal use-local (717) is a logic LOW, signal 211 is selected as MUX output on path 737.

PWM level converter 745 operates to generate a binary signal on path 747 based on the logic level of tri-stated signal PWMA received on path 737. In an embodiment, 743 is implemented as a weak pull-up resistor (i.e., having a large resistance value) in order to keep input to inverter 744 LOW, except when forced to logic HIGH by signal PWMA. Inverter 744 is implemented as a MOS inverter. Thus, when a logic LOW is received on path 737, block 745 generates a logic HIGH on path 747, and maintains a logic LOW on path 747 otherwise.

SR-latch 750 is shown receiving signal neg-volt (363) on the set input and signal zero-current (373) on the reset input. Q-output of SR-latch 750 is shown provided on paths 313-2 to 313-4.

OR gate 765 receives signals LS-drive (747) and Q-output (753) of SR-latch and generates OR-output, which is shown connected to path 313-1.

In operation, a logic LOW is received on path 212 (SYNC-A) in DCM, and thus a logic HIGH is generated on path 704 (is-DCM). In the illustrative embodiment, it is assumed that the configuration bit has value ‘0’ indicating that phase controller 210 computes magnitudes of T-off-1 and T-deadtime-1. Accordingly, drive control block generates a logic LOW on path 717. Thus, MUX 735 forwards signal 211 on path 737.

Referring back to FIG. 4, the state of signals in each PWM cycle is as described below:

In the duration t410-t413:

PWMA (211)/737 is a logic LOW. Thus, signal 747 is a logic HIGH in the duration, and accordingly en-LS [1] is a logic HIGH.

Signals neg-volt and zero-current are at logic LOW, and accordingly Q-output of SR-latch is a logic LOW. Thus, signals en-LS [2] to en-LS [4] are at logic LOW. Thus, only ¼^{th} portion of LS switch 330 is turned ON in the first LS-phase. It may be appreciated that if a different number of sections of LS switch 330 were to be turned ON in the first LS duration, output of OR gate 765 may be connected to the corresponding gate drive signals.

In the duration t413-t416:
PWMA/737 is at Hi-Z. Thus, signal 747 is a logic LOW in the duration.
Signals neg-volt and zero-current are at logic LOW, and accordingly Q-output of SR-latch is a logic LOW. Thus, signals en-LS [1] to en-LS [4] are at logic LOW. Accordingly, LS switch is OFF.

In the duration t416-t419:

PWMA/737 is a logic HIGH. Thus, signal 747 is a logic LOW in the duration.

Signals neg-volt and zero-current are at logic LOW, and accordingly Q-output of SR-latch is a logic LOW. Thus, signals en-LS [1] to en-LS [4] are at logic LOW. Accordingly, LS switch is OFF.

Though not shown in FIG. 7, when PWMA is a logic HIGH, gate driver 310 generates a logic HIGH on path en-HS in a known way.

In the duration t419-t422:
PWMA/737 is at Hi-Z. Thus, signal 747 is a logic LOW in the duration.
Signal zero-current is at logic LOW, while signal neg-volt is asserted to logic HIGH at t422 and accordingly, Q-output of SR-latch is a logic HIGH starting at t422. Thus, signals en-LS [1] to en-LS [4] are driven to logic HIGH starting at t422. Accordingly, LS switch is turned ON fully at t422.

At t425:

PWMA/737 continues to be at Hi-Z. Thus, signal 747 continues to be at logic LOW.

Signal neg-volt is at logic LOW, while signal zero-current is asserted to logic HIGH at t425. Accordingly, SR-latch is reset, thereby signals en-LS [1] to en-LS [4] are driven to logic LOW. Thus, LS switch is turned OFF at t425.

In the duration t425-t427:

PWMA/737 continues to be at Hi-Z. Thus, signal 747 continues to be at logic LOW.

Signal neg-volt is at logic LOW, while signal zero-current remains asserted at logic HIGH. Accordingly, Q-output is at logic LOW, thereby signals en-LS [1] to en-LS [4] are maintained at logic LOW. Thus, LS switch remains OFF until the start of the next cycle of PWMA.

Although the illustrative embodiment depicts a particular technique for generating LS drive signals, alternative techniques may be employed to generate LS drive signals with appropriate changes to the gate driver circuitry, as will be apparent to a skilled practitioner by reading the disclosure herein. For example, in an alternative embodiment, a Hi-Z to logic LOW transition of signal PWMA may be detected and used to turn on a portion of LS switch 330 in the first LS-phase.

Thus, techniques of the present disclosure techniques may reduce losses and improve efficiency of a switching converter operating under light load conditions.

The description is continued to illustrate an example implementation of a negative-threshold voltage detector block in an embodiment of the present disclosure.

### 9. Negative-Threshold Voltage Detector

FIG. 8 is a block diagram of a negative-threshold voltage detector implemented in a power stage, in an embodiment of the present disclosure. Negative-threshold voltage detector 340 is shown containing current sources 805, 810, resistor 820, N-channel MOSFETs 830 and 840, and inverter 850. Vcc (201) represents a supply voltage (e.g., 3.3V) received from a source external to SPS 220-1 (for example from phase controller 210). Magnitude of voltage V1 (802) equals (gate-source) threshold voltage (Vt1) of transistor 830 plus a small voltage, Vdelta1 (by which the voltage at gate of transistor 830 exceeds Vt1).

Due to the voltage drop (Vdelta2) across resistor 820, gate voltage (V2, 804) of transistor 840 will be equal to V1 (802) minus Vdelta2. The magnitude of resistor 820 is designed such that V2 (804) is close to (gate-source) threshold voltage (Vt2) of transistor 840. In an embodiment, V2=Vt2 minus 0.7 V (depicted as SW-neg in FIG. 4).

Thus, when voltage SW-1 is above the threshold (equal to or greater than the threshold voltage), transistor 840 is switched OFF, and output 363 of inverter 850 is a logic LOW. However, when SW-1 (221-1) is negative and reaches a magnitude SW-neg, transistor 840 is switched ON, and output 363 of inverter 850 is a logic HIGH.

Although the illustrative embodiment is shown employing the circuit of FIG. 8 in order to detect negative threshold voltage at the SW node, it may be appreciated that alternative embodiments may employ different circuit(s) for negative-threshold voltage detection.

### 10. Conclusion

References throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

While in the illustrations of FIGS. 1, 2, 3, 5, 6, 7 and 8, although terminals/nodes are shown with direct connections to (i.e., “connected to”) various other terminals, it should be appreciated that additional components (as suited for the specific environment) may also be present in the path, and accordingly the connections may be viewed as being “electrically coupled” to the same connected terminals.

In the instant application, the power and ground terminals are referred to as constant reference potentials.

While various embodiments of the present disclosure have been described above, it should be understood that they have been presented by way of example only, and not limitation. Thus, the breadth and scope of the present disclosure should not be limited by any of the above-described embodiments, but should be defined only in accordance with the following claims and their equivalents.

What is claimed is:

1. A switching converter comprising:
a high-side switch and a low-side switch coupled in series at a switching node, and together operable to provide a regulated supply voltage at an output node based on an input voltage received at an input node, wherein said input voltage is of a first magnitude, said high-side switch and said low-side switch being connected in series between said input node and a ground terminal providing a constant reference potential, wherein an inductor is coupled between said switching node and said output node, wherein said high-side switch and said low-side switch respectively drive said inductor based on a control signal; and
a gate driver block to drive each of said high-side switch and said low side switch to be on or off based on a logic level of said control signal,
wherein an effective parasitic capacitance is present between said switching node and said ground terminal,
wherein said gate driver block drives said high-side switch and said low-side switch such that, in a cycle of said control signal:
at a first time instance, said low-side switch is turned on with said high-side switch being off;
at a second time instance following said first time instance, said low-side switch is turned off with said high-side switch remaining off; and
at a third time instance following a delay duration from said second time instance, said high-side switch is turned on with said low-side switch remaining off,
wherein by said third time instance, a voltage across said effective parasitic capacitance reaches only a fraction of said first magnitude, wherein said voltage across said effective parasitic capacitance thereafter rises to said first magnitude while said high-side switch continues to be on from said third time instance, wherein said fraction is less than one.

2. The switching converter of claim 1, wherein said cycle of said control signal starts at said first time instance,
wherein the time duration bounded by said first time instance and said second time instance equals a first pre-computed value such that a current through said inductor reaches a pre-determined magnitude by said second time instance,
wherein said delay duration equals a second pre-computed value.

3. The switching converter of claim 1, said gate driver block is further operable to drive said high-side switch and said low-side switch such that, in said cycle of said control signal:
at a fourth time instance following said third time instance, said high-side switch is turned off with said low-side switch remaining off;
at a fifth time instance following said fourth time instance, said low-side switch is turned on with said high-side switch remaining off; and
at a sixth time instance following said fifth time instance, said low-side switch is turned off with said high-side switch remaining off,
wherein by said fifth time instance, a voltage at said SW node reaches a first negative-threshold value, wherein voltage at said SW node thereafter rises to zero while said low-side switch is on from said fifth time instance,
wherein said current through said inductor reaches zero by said sixth time instance.

4. The switching converter of claim 1, wherein said effective parasitic capacitance is an equivalent capacitance of a combination of a first parasitic capacitance present between current terminals of said high-side switch and a second parasitic capacitance present between current terminals of said low-side switch.

5. The switching converter of claim 3, wherein said low-side switch comprises a plurality of sections arranged in parallel, wherein each section of said plurality of sections comprises a corresponding plurality of transistors, wherein each transistor of said plurality of transistors comprises a first current terminal, a second current terminal and a control terminal, wherein said control terminals of said plurality of transistors of a corresponding section are tied together,
wherein each section is operable to be controlled by a corresponding common-gate-drive signal driving corresponding control terminals of said plurality of transistors,
wherein when said common-gate-drive signal of a section of said plurality of sections is driven to a first logic state, said corresponding plurality of transistors of said section is turned ON, wherein when said common-gate-drive signal of a section of said plurality of sections is driven to a second logic state, said plurality of transistors of said section is turned OFF,
wherein in the time duration between said first time instance and said second time instance, said common-gate-drive signals of a first subset of said plurality of sections are driven to a first logic state with the remaining common-gate-drive signals being driven to a second logic state,
wherein in the time duration between said fifth time instance and said sixth time instance, said common-gate-drive signals of all of said sections of said plurality of sections are driven to said first logic state.

6. The switching converter of claim 5, wherein said switching converter operates in one of a continuous conduction mode (CCM) only and a discontinuous conduction mode (DCM),
wherein said switching converter operates in CCM when a load-current requirement exceeds a threshold current value, and in DCM otherwise,
wherein a mode-signal is in said second logic state when said switching converter is operating in DCM,
wherein said first logic state is a logic HIGH and said second logic state is a logic LOW.

7. The switching converter of claim 6, wherein said switching converter further comprises:
a negative-threshold voltage detector coupled to receive said control signal and a voltage at said SW node, and to generate a negative-threshold-crossed signal in said first logic state when said voltage at said SW node exceeds said first negative-threshold value; and
a zero-current detector coupled to the path on which current through said inductor flows, and to generate a zero-current indicator signal in said first logic state when the magnitude of said current is zero.

8. The switching converter of claim 6, wherein said switching converter comprises a memory storing a configuration bit,
wherein said gate driver block comprises:
a first inverter coupled to receive said mode-signal and to generate a first inverter-output;
a drive control block coupled to receive said first inverter-output and said configuration bit, and to generate a local-indicator signal, wherein said drive control block generates a logic HIGH when said first inverter-output is a logic HIGH and said configuration bit is a logic HIGH;
a PWM-local generator block coupled to receive said control signal and said local-indicator signal and compute-input comprising an inductance value of said inductor, a magnitude of said effective parasitic capacitance, said desired magnitude, said fraction, and to generate a PWM-local signal,
wherein PWM-local generator block computes said first pre-computed value, said first pre-determined magnitude and said second pre-computed value based on said compute-input when said local-indicator signal is a logic HIGH, wherein said PWM-local generator block generates PWM-local signal specifying said first time instance, said second time instance, said third time instance, said fourth time instance, said fifth time instance and said sixth time instance;
a multiplexer (MUX) coupled to receive said control signal and said PWM-local signal as inputs, said local-indicator signal as a select signal, said MUX to forward said control signal as a MUX-output when said local-indicator is a logic LOW, said MUX to forward said PWM-local signal as said MUX-output when said local-indicator signal is a logic HIGH;
a PWM-level converter block coupled to receive said MUX-output and to generate an LS-drive signal, wherein said PWM-level converter generates a logic HIGH when said MUX-output is a logic LOW, and a logic LOW otherwise;
an SR-latch coupled to receive said negative-threshold-crossed signal at a set-input, said zero-current indicator signal as a reset-input, said SR-latch to generate a Q-output based on said set-input and said reset-input; and
an OR gate coupled to receive said Q-output and said LS-drive as inputs, said OR gate to generate an OR-output,
wherein said OR-output is coupled to said common-gate-drive signals of said first subset of said plurality of sections, wherein said Q-output is coupled to said remaining common-gate-drive signals of said sections.

9. The switching converter of claim 8, wherein said negative-threshold voltage detector comprises:
a resistor;
a second inverter;
a first current source coupled between a second constant reference potential and a first end of said resistor;
a first transistor, wherein a first current terminal of said first transistor is coupled to a second end of said resistor, wherein a second current terminal of said first transistor is coupled to said first constant reference potential, wherein a control terminal of said first transistor is coupled to the junction of said first current source and said first end of said resistor;
a second transistor, wherein a control terminal of said second transistor is coupled to said second end of said resistor, wherein a first current terminal of said second transistor is coupled to an input of an input of said second inverter, wherein a second current terminal of said second transistor is coupled to said SW node; and
a second current source coupled between said second constant reference potential and said input of said second inverter,
wherein a logic HIGH at an output of said second inverter indicates that said voltage at said switching node is equal to or greater than said first negative-threshold value, and a logic LOW at said output of said second inverter indicates otherwise.

10. A voltage regulator module (VRM) comprising:
a power stage comprising:
a high-side switch and a low-side switch coupled in series at a switching node, and together operable to provide a regulated supply voltage of a desired magnitude at an output node based on an input voltage received at an input node, wherein said input voltage is of a first magnitude, said high-side switch and said low-side switch being connected in series between said input node and a ground terminal providing a first constant reference potential, wherein an inductor is coupled between said switching node and said output node, wherein said high-side switch and said low-side switch respectively drive said inductor based on a control signal; and
a gate driver block to drive each of said high-side switch and said low side switch to be on or off based on a logic level of said control signal,
wherein an effective parasitic capacitance is present between said switching node and said ground terminal,
wherein said gate driver block drives said high-side switch to an on condition in a first duration and said low-side switch to an on condition in a second duration in each cycle of said control signal, wherein a magnitude of said first duration is such that said regulated supply voltage is maintained at said desired magnitude in steady-state, said gate driver block driving said low-side switch and said high side switch further such that, in a cycle of said control signal:
at a first time instance, said low-side switch is turned on with said high-side switch being off;
at a second time instance following said first time instance, said low-side switch is turned off with said high-side switch remaining off; and
at a third time instance following a delay duration from said second time instance, said high-side switch is turned on with said low-side switch remaining off,
wherein by said third time instance, a voltage across said effective parasitic capacitance reaches only a fraction of said first magnitude, wherein said voltage across said effective parasitic capacitance thereafter rises to said first magnitude while said high-side switch continues to be on from said third time instance, wherein said fraction is less than one; and
a phase controller providing at least said magnitude of said first duration in said control signal.

11. The VRM of claim 10, wherein said cycle of said control signal starts at said first time instance,
wherein the time duration between said first time instance and said second time instance equals a first pre-computed value such that a current through said inductor reaches a pre-determined magnitude by said second time instance,
wherein said delay duration equals a second pre-computed value such that a voltage across said effective parasitic capacitance reaches said fraction of said first magnitude by said third time instance.

12. The VRM of claim 11, wherein said gate driver block is further operable to drive said high-side switch and said low-side switch such that, in said cycle of said control signal:
at a fourth time instance following said third time instance, said high-side switch is turned off with said low-side switch remaining off;
at a fifth time instance following said fourth time instance, said low-side switch is turned on with said high-side switch remaining off; and
at a sixth time instance following said fifth time instance, said low-side switch is turned off with said high-side switch remaining off,
wherein by said fifth time instance, a voltage at said SW node reaches a first negative-threshold value, wherein voltage at said SW node thereafter rises to zero while said low-side switch is on from said fifth time instance,
wherein said current through said inductor reaches zero by said sixth time instance.

13. The VRM of claim 12, wherein said phase controller comprises:
a first memory storing a first configuration bit;
a control block coupled to receive said regulated supply voltage and a reference voltage of said desired magnitude, and to generate an error signal based on difference in magnitude between said reference voltage and said regulated supply voltage;
a mode block coupled to receive said threshold current value and information comprising present load-current, and to generate a mode signal in a logic HIGH state when said present load-current is less than said threshold current value, and in logic LOW state otherwise;
a PWM-generator block coupled to receive said error signal, said mode signal, said information comprising present load-current, and to generate an operation-mode-indicator signal and a common control signal,
wherein said PWM-generator block generates said operation-mode-indicator signal in logic LOW state when said mode signal is a logic HIGH, wherein said PWM-generator block generates said common control signal based at least on said information comprising present load-current;
a phase manager block coupled to receive said operation-mode indicator signal, said common control signal and phase-management-information comprising present load-current, said desired magnitude and said first magnitude, said phase manager block to generate said control signal and a SYNC signal; and
a logic block coupled to receive said mode signal, compute-information comprising an inductance value of said inductor, a magnitude of said effective parasitic capacitance, said desired magnitude, said fraction, and to generate said first pre-computed value and said second pre-computed value,
wherein when said mode signal is a logic HIGH:
said phase manager block operates only said power stage in an active state, wherein said phase manager block forwards said common control signal as said control signal to said power stage, wherein said phase manager block forwards said operation-mode indicator signal as said SYNC signal to said power stage,
wherein when said first configuration bit is a logic HIGH:
said logic block is operable to compute said first pre-computed value, said pre-determined magnitude and said second pre-computed value based on said compute-information,
wherein said PWM-generator block generates said common control signal based on said first pre-computed value and said second pre-computed value, wherein said control signal specifies said first time instance, said second time instance, said third time instance and said fourth time instance.

14. The VRM of claim 10, wherein said effective parasitic capacitance is an equivalent capacitance of a combination of a first parasitic capacitance present between current terminals of said high-side switch and a second parasitic capacitance present between current terminals of said low-side switch.

15. The VRM of claim 13, wherein said low-side switch comprises a plurality of sections arranged in parallel, wherein each section of said plurality of sections comprises a corresponding plurality of transistors, wherein each transistor of said plurality of transistors comprises a first current terminal, a second current terminal and a control terminal, wherein said control terminals of said plurality of transistors of a corresponding section are tied together,
wherein each section is operable to be controlled by a corresponding common-gate-drive signal driving corresponding control terminals of said plurality of transistors,
wherein when said common-gate-drive signal of a section of said plurality of sections is driven to a first logic state, said corresponding plurality of transistors of said section is turned ON, wherein when said common-gate-drive signal of a section of said plurality of sections is driven to a second logic state, said plurality of transistors of said section is turned OFF,
wherein in the time duration between said first time instance and said second time instance, said common-gate-drive signals of a first subset of said plurality of sections are driven to said first logic state with the remaining common-gate-drive signals being driven to said second logic state,
wherein in the time duration between said fifth time instance and said sixth time instance, said common-gate-drive signals of all of said sections of said plurality of sections are driven to said first logic state.

16. The VRM of claim 15, wherein said power stage further comprises:
a negative-threshold voltage detector coupled to receive said control signal and a voltage at said SW node, and to generate a negative-threshold-crossed signal in a logic HIGH state when said voltage at said SW node exceeds said first negative-threshold value; and
a zero-current detector coupled to the path on which current through said inductor flows, and to generate a zero-current indicator signal in a logic HIGH state when the magnitude of said current is zero.

17. The VRM of claim 16, wherein said power stage comprises a second memory storing a second configuration bit,
wherein said gate driver block comprises:
a first inverter coupled to receive said SYNC signal and to generate a first inverter-output;
a drive control block coupled to receive said first inverter-output and said second configuration bit, and to generate a local-indicator signal in a logic HIGH state when said first inverter-output is a logic HIGH and said second configuration bit is a logic HIGH;
a PWM-local generator block coupled to receive said control signal, said local-indicator signal and compute-input comprising an inductance value of said inductor, a magnitude of said effective parasitic capacitance, said desired magnitude, said fraction, and to generate a PWM-local signal;
a multiplexer (MUX) coupled to receive said control signal and said PWM-local signal as inputs, said local-indicator signal as a select signal, said MUX to forward said control signal as a MUX-output when said local-indicator is a logic LOW, said MUX to forward said PWM-local signal as said MUX-output when said local-indicator signal is a logic HIGH;
a PWM-level converter block coupled to receive said MUX-output and to generate an LS-drive signal, wherein said PWM-level converter generates a logic HIGH when said MUX-output is a logic LOW, and a logic LOW otherwise;
an SR-latch coupled to receive said negative-threshold-crossed signal at a set-input, said zero-current indicator signal as a reset-input, said SR-latch to generate a Q-output based on said set-input and said reset-input; and
an OR gate coupled to receive said Q-output and said LS-drive as inputs, said OR gate to generate an OR-output,
wherein said OR-output is coupled to said common-gate-drive signals of said first subset of said plurality of sections, wherein said Q-output is coupled to said remaining common-gate-drive signals of said sections,
wherein when said local-indicator signal is a logic HIGH:
said PWM-local generator block computes said first pre-computed value, said first pre-determined magnitude and said second pre-computed value based on said compute-input, wherein said PWM-local generator block generates PWM-local signal specifying said first time instance, said second time instance, said third time instance, said fourth time instance, said fifth time instance and said sixth time instance.

18. The VRM of claim 17, wherein said negative-threshold voltage detector comprises:
a resistor;
a second inverter;
a first current source coupled between a second constant reference potential and a first end of said resistor;
a first transistor, wherein a first current terminal of said first transistor is coupled to a second end of said resistor, wherein a second current terminal of said first transistor is coupled to said first constant reference potential, wherein a control terminal of said first transistor is coupled to the junction of said first current source and said first end of said resistor;
a second transistor, wherein a control terminal of said second transistor is coupled to said second end of said resistor, wherein a first current terminal of said second transistor is coupled to an input of an input of said second inverter, wherein a second current terminal of said second transistor is coupled to said SW node; and
a second current source coupled between said second constant reference potential and said input of said second inverter,
wherein a logic HIGH at an output of said second inverter indicates that said voltage at said switching node is equal to or greater than said first negative-threshold value, and a logic LOW at said output of said second inverter indicates otherwise.
